(19) United States
(12) Patent Application Publication
(10) Pub. No.: US 2014/0365887 A1
(43) Pub. Date: Dec. 11, 2014

(54) INTERACTIVE PLATFORM GENERATING MULTIMEDIA FROM USER INPUT

(71) Applicant: Kirk Robert CAMERON, Austin, TX (US)

(72) Inventor: Kirk Robert CAMERON, Austin, TX (US)

(21) Appl. No.: 14/286,651

(22) Filed: May 23, 2014

Related U.S. Application Data
(60) Provisional application No. 61/833,242, filed on Jun. 10, 2013.

(51) Int. Cl. G06F 17/30; G06F 3/0481

(52) U.S. Cl. CPC G06F 17/30058; G06F 3/0481
USPC 715/716

(57) ABSTRACT

Embodiments presented herein provide techniques for generating a collage of multimedia (e.g., visual and auditory media) based on data associated with a user. The collage may be used as an audio/visual messaging sharing vehicle. A platform engine receives user profile information and a selection of a performance mode from a client device. The platform engine generates a set of calls for user action prompts (e.g., questions or other requests for input) based on the selected performance mode and user information. The platform engine sends the set of prompts to the client device, and upon receiving responses to the prompts from the client device, the platform engine correlates the responses and the user profile information with media items in the media library. Based on the correlation, the platform engine generates the multimedia collage and sends the collage to the client device.

### BACKGROUND

The need for personal self-expression has existed since the beginning of man. From caveman drawings to selfies, a newly adopted word denoting the cultural phenomenon of self-portraiture, we have an insatiable passion to share ourselves. With that instinctual desire to convey oneself, frustration often comes for those who have difficulty in expressing themselves in a meaningful and artistic manner. As society continues toward visual and auditory methods of communication rather than written communication, individuals who lack technical prowess or aesthetic skills have even fewer social opportunities for self-expression.

New technologies can assist in self-examination, self-expression and distribution of online identities. Further, such technologies may aid those who are unable or reluctant to communicate through traditional methods. For example, popular social networks (e.g., Facebook, Instagram, WhatsApp, etc.) allow individuals to find new avenues to express themselves with friends and strangers. Their thoughts and feelings may be exhibited in user-generated content that is digitally distributed across a network. However, such technologies have yet to fully exploit other potential means of self-expression.

### SUMMARY

Embodiments provide a method for generating a collage of multimedia. The method may generally include receiving user profile information and a selection of a performance mode from a client device. The method may also include generating one or more prompts based on the selected performance mode and on the user profile information. Each of the one or more prompts corresponds to one of a plurality of media items stored in a data store. The media item can be one of an image, a sound, a video, or text stored in a first data store. The method may generally include sending the one or more prompts to the client device. The method may also generally include receiving responses to each of the one or more prompts from the client device. Each of the responses correspond to one or more of the media items stored in the first data store. The method may include correlating the responses and the profile information with statistical data stored in a second data store and the plurality of media items. The method may also include generating a collage of multimedia based on the correlated responses, profile information, and media items. The collage of multimedia includes at least one of the media items.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIG. 2 illustrates a platform engine executing on a platform server computing system, according to one embodiment.

FIGS. 3A and 3B illustrate example touch-screen interfaces of a user device application configured to communicate with a platform server, according to one embodiment.

FIG. 4 illustrates an example media item configuration interface of a platform server, according to one embodiment.

FIG. 5 illustrates a method for generating a collage of multimedia based on analyses of user input, according to one embodiment.

FIG. 6 illustrates an example platform server computing system, according to one embodiment.

### DETAILED DESCRIPTION

Embodiments presented herein provide a platform and techniques for generating a collage of multimedia (e.g., image, sound, video, etc.) representative of user information and input. In one embodiment, a platform engine generates a set of questions in response to a selection of a mode option sent by an application running on a user device. The questions may be based on user data (e.g., user profile information, social media profile information, usage history, etc.). The platform engine sends the set of user input requests (e.g., generally in the form of questions) to the application. Thereafter, the platform engine receives input in response to the questions from the application. Once received, the platform engine performs a variety of analytics and digital effects processing methods to generate a collage of multimedia that is based on the analysis of the inputs and the user data. The generated collage may include multimedia from different sources, such as a media library of the platform engine, real-time data source feeds (e.g., published news, geo-local information, etc.), advertising sources, and social media user profiles. The platform engine sends the collage to the application. The multimedia collage is a visual and/or auditory experience that is representative of the responses provided by a user running the application. After the application receives the collage, the application may send the collage to various outlets for sharing, such as e-mail, social networks, text message, and the like.

The platform may be construed as a game for entertainment and/or as a tool for personal growth and communication. Portions of the platform described herein may be isolated and enhanced for other uses such as mental health analysis, education, stand-alone text-to-audio/visual media conversion and communication, online dating services, and data presentation. The platform may encourage deeper and more meaningful conversations between individuals and further may act as a method of communication for people who do not have the ability to communicate subjective thoughts and feelings.

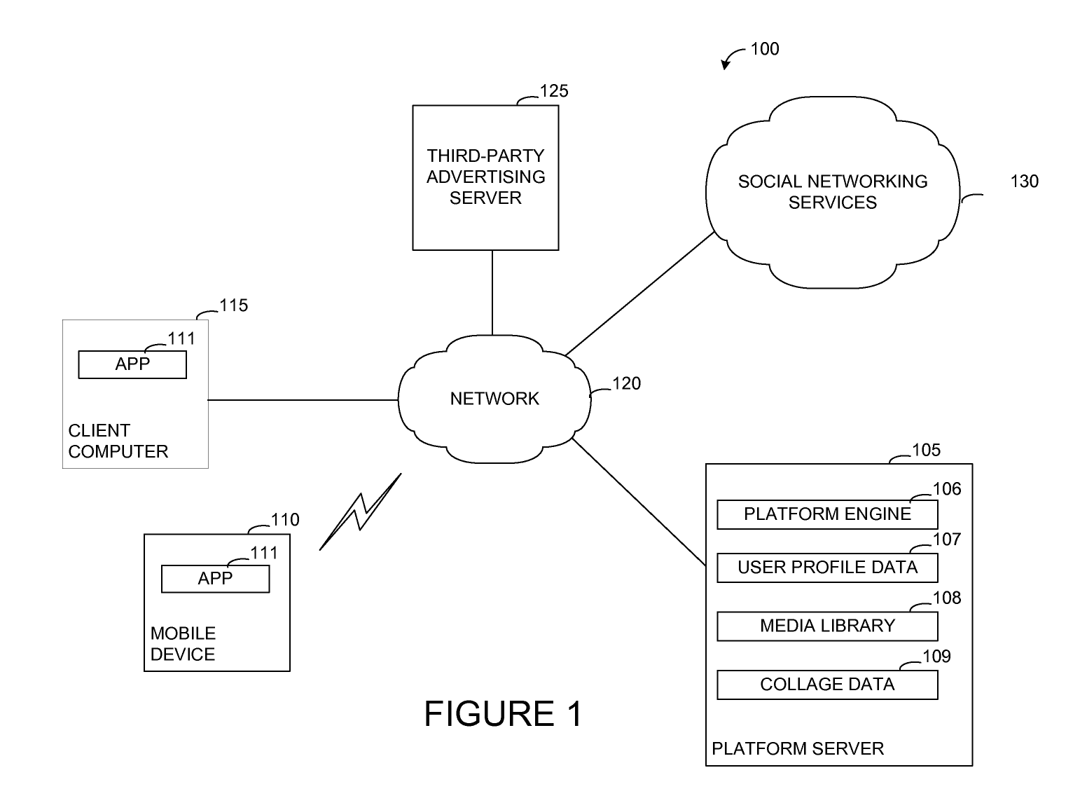

FIG. 1 illustrates an example computing environment 100, according to one embodiment. As shown, the computing environment 100 includes a platform server 105. The platform server 105 includes a platform engine 106, user profile data 107, a media library 108, and collage data 109. A user may communicate with the platform server 105 via a device connected over a network 120 (e.g., the Internet). Examples of such devices may include mobile phones, tablets, wearable devices, desktop computers, laptop computers, and the like. A mobile device 110 and a client computer 115 are shown as reference examples of devices that communicate with the platform server 105. Illustratively, the mobile device 110 and the client computer 115 include an application (app) 111 that communicates with the platform server 105.

The platform engine 106 manages platform processes, various users, data repositories, media repositories, data archives, real-time data source feeds, and platform states. In one embodiment, the platform engine 106 generates questions to send to the app 111. After receiving responses to the questions from the app 111, the platform engine 106 generates a collage of multimedia based on the responses, real-time data sources, and the user profile data 107. The collage of multimedia may include image, sound, and/or other data (e.g., real-time data, video data, etc.) provided by the media library 108.

The media library 108 is a data store that includes image, video, and sound media items that may be created specifically for the platform engine 106 or may be obtained from third-party source libraries. Further, the media library 108 may also include media items uploaded, catalogued, and managed by individual users. The media library 108 is dynamic and may be periodically updated with additional media items. Each media item in the media library 108 is categorized with tags. Tags may be individual properties, descriptions and associated moods. Further, tags may be held in a data container within the media item file itself, such as metadata, or in a separate database used by the platform engine for retrieval of appropriate media to be used by the platform engine 106 to generate correlated relationship heuristics, associations, moods and contexts of media and information to be presented back to the user. Properties defined in the tags may include various image taxonomies, keywords, denotations, connotations, colors, actions, uses, locations, periods of time, moods, emotions, conditions and other relevancies associated with each media file.

The tag data is organized into an index searchable by the platform engine 106. Based on the tag data, the platform engine 106 identifies and acquires media to be used in generating questions and collages. The platform engine 106 may manipulate or adjust the media items to enhance experiential properties or function. The platform engine 106 may also alter the media items to optimize the performance of the platform.

Further, the platform engine 106 may assess proprietary qualitative values of media and text messages and use proprietary algorithms for heuristic automation or manual assessment. To do so, the platform engine 106 may qualify media keywords, phrases, and other criteria with associated concepts and properties. The platform engine 106 may also use manual input (e.g., of an administrator of the platform engine 106) to assess the qualitative values of the media and text messages. Value assessment may be determined in the media library 108 (or other media libraries) or determined real-time as input responses from the app 111 dictate the media selected for the experience. The platform engine 106 may evaluate new, special, or custom items for the media library 108 and associated databases. The platform engine 106 determines anthropomorphic qualities and psychological state-traits, such as mood polarities (e.g., anger and peace), of the media items and other relevant properties such as size, color, complexity, usefulness of such media. The platform engine 106 also assesses the manner in which the media item has previously been used (e.g., whether as a question or as a component in a multimedia collage). Technologies may be employed to automatically identify, isolate and/or manipulate media items stored in the media library 108. Likewise, similar technologies may be used to analyze and optimize media uploaded by the user into a user profile. Such technologies may include tools for automatically creating stereoscopic image channels from a single monocular image source. For instance, technologies may be used to isolate and remove the background behind a user likeness or foreground subject in a photograph. As another example, technologies may be used to identify objects or people within an image or media clip. Media in such libraries may include video, moving images, photos, drawings, textures, colors, shapes, graphic devices, text and any other visual element. Similarly, audio elements (e.g., music) may be collected, tagged and enhanced for use in conjunction with, or instead of visual imagery.

Once the multimedia collage is generated, the platform engine 106 sends the collage to the app 111. Further, the platform server 106 may store the generated collage as collage data 109. Although FIG. 1 depicts components of the platform server 105 as being hosted by a single server computer, the components may be hosted separately on multiple physical or virtual servers (e.g., on a cloud network).

In one embodiment, the app 111 may communicate with the platform server 105 and provide user information to create an individual profile, stored on the platform server 105 as user profile data 107. The user profile data 107 may include personal information (e.g., age, gender, relationship status). The user profile data 107 may also include other data such as personal beliefs, affinities, hobbies, interests and subjective values. Further, financial information such as credit card data may also be stored in the user profile data 107 for payment purposes, if and when applicable, or stored in third-party platforms such as PayPal. Once the user profile data 107 for a given user is created, the app 111 may provide user profile pictures and other media pertinent to the user to be used by various platform functions. Note, although a user is not required to create and maintain user profile data 107, creating a profile enhances a user experience by allowing the user to store, archive, process, and share data associated with the platform.

The platform engine may also allow the app 111 to associate the profile to third-party accounts and profiles of other social networking services 130, such as Facebook, Instagram, Twitter, YouTube, and Pinterest. Associating the profile to such social networking services 130 allows the platform engine to access additional information and media associated with the user. The platform engine may also derive and employ heuristic associations, statistics, or trends from other related platform users or from third-party sources (e.g., Google, Amazon, and the like), all of which may enhance the user experience.

In one embodiment, a third-party advertising server 125 may provide the platform server 105 with advertisements that may be presented to a user through the app 111. Such advertisements may include video or animated commercials, banner advertisements, and display advertisements. In addition, the third-party advertising server 125 may provide specific and targeted advertisements or opinion polls that are embedded in calls for user input (e.g., questions) generated by the platform engine 106 or manually written (e.g., by a platform administrator). The advertisements may be presented, manipulated, archived, and shared just as any other media item in the media library 108. Such advertisements may be specifically optimized for platform performance and mutually arranged with the third-party advertising server 125 to maximize advertisement integration and potential to influence users.

Further, a sales infrastructure may create a virtual marketplace where advertising entities develop targeted questions for the platform to promote ideas, products and services for the advertising entities. In such a marketplace, the advertising entities may target the questions to certain users based on demographic information provided in a given user profile (or sets of user profiles) or based on responses provided by a given user (or sets of users). The advertising entities may then target advertisements embedded into the app 111 (e.g., with computer code or cookies embedded into the app 111). Additionally, consumer opinion polls may be developed and deployed within the virtual advertising marketplace where data mining services purchase and collect user input data. The user data obtained by the platform may be aggregated, analyzed and converted for supplemental third-party usage. The virtual marketplace structure of the platform may be adjusted to conform to future regulations that limit advertising, data harvesting, and advocate consumer privacy.

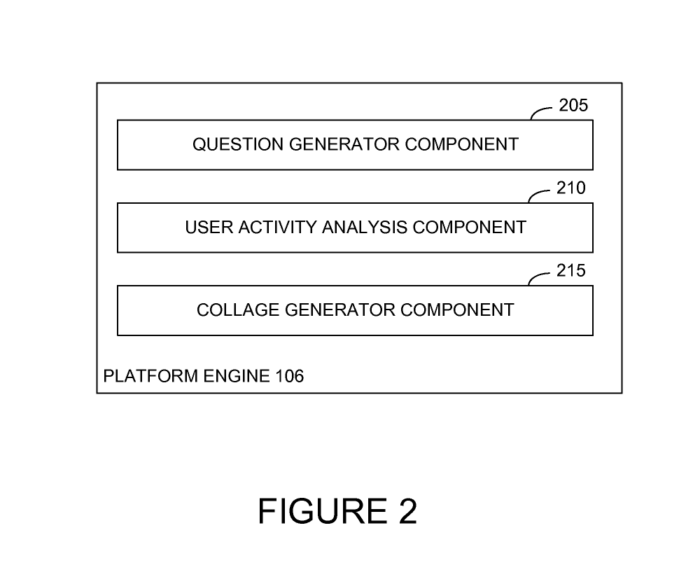

FIG. 2 further illustrates the platform engine 106, according to one embodiment. As shown, the platform engine 105 includes a question generator component 205, an analysis component 210, and a collage generator component 215.

The platform engine 106 receives different types of input from an app 111. Such input may be selections of platform modes, input provided in response to various prompts, and defining peer-to-peer and peer-to-many networks. In one embodiment, based on a selection of a platform mode and a corresponding user profile, the question generator component 205 creates a set of calls for user input, also known as prompts (e.g., questions) to send to the app 111. The prompts may be generated as text, images, sounds, or a mix of each. In one embodiment, the question generator component 205 may store the set of prompts in a repository, such as a database or other type of data store (not shown). The question generator component 205 manages the stored source media data, question-authoring data, real-time data sources, and data acquired from previous user analyses.

In some modes, the question generator component 205 may be configured to generate subsequent questions based on previous response input sent by the app 111. Questions and question progressions may be determined by the platform engine 106 or manually specified (e.g., by a platform administrator, guest authors invited by platform administrators, individual platform users, etc.). For instance, the question generation component 205 may identify keywords and data associated with items in the media library 108 along with user data to develop several contexts for questions. Each keyword provided for each response may be associated with many different media items within the library. Therefore, many permutations of each prompt-to-keyword instance may be generated from a single keyword association statement. For instance, if the keyword for response A is the keyword “fire,” various media may be selected to represent response A, such as images of a flame and images of a weapon discharging. This allows many different versions of the same prompt-response question to be generated with a single prompt-keyword construction. Although questions authored by platform administrators or those which are autonomously generated by the platform may deploy many variants on the same statement, a user authoring a question may be able to view a list of the associated media found and select the specific media to be displayed for each response option. Further, when the user authors specific questions and responses from an analysis set of questions, the user may employ media uploaded to his or her personal media library within the profile. These personal library media may have contexts and meanings that may only be appropriately understood by the user-author and users to whom he shares the question(s). Accordingly, such questions would not normally be deployed to any user outside of that defined group. In reference to determining the sets, these sequences of user interrogation, prompts, and question progressions may be structured in various manners to obtain specific types of information and are based on the general purpose of the user mode selected for engaging the platform. As one example, these differing lines of questioning may be intended for maximum user entertainment rather than sober psychological evaluation and therefore enhance a more humorous engagement with the platform.

In one embodiment, the analysis component 210 is configured to receive responses sent from the app 111 and assess the responses. The analysis component 210 correlates similarities of values, keywords, descriptions, quality, or conceptual contexts of the questions and responses with media of the media library 108 (or other media obtained from third-party collections). Such correlations may be performed, for example, through mathematical algorithms, artificial intelligence, heuristics, and other data processing techniques or licensed (in part or in whole) from other sources.

In one embodiment, the collage generator component 215 is configured to create a multimedia collage based on the correlations received from the analysis component 210. As stated, the multimedia collage may include various image, video, and sound media from the media library 108 (or other sources).

The collage generator component 215 may create the multimedia collage through various image and sound processing techniques and effects. Apart from the layering of multiple visual or auditory elements in conjunction or in juxtaposition with one another, visual layers may include various opacity values assigned to generate looks that do not resemble the original media. Further, the collage generator component 215 also uses image blending techniques, such as additive, subtractive, multiply, divide, soft light, hard light, pin light, lighten, darken, hue, saturation and difference mixing and layering. Such techniques achieve varied looks, e.g., by allowing certain color values, luminance values, or differences between two or more layered images to be passed through without change, with changes, or filtered entirely from the resulting composite image. In addition, the collage generator component 215 may use digital image processing techniques such as invert color, posterize, resize, reposition, shatter, recolor, retime, stretch, squash, flip, rotate, mask, matte, blur, defocus, glow, brighten, and the like. Further, such manipulated images may be mapped onto virtual objects to create artificial perspectives and objective space as generally performed in 3-dimensional (3D) visual effects, design, and animation. Such digital image processing techniques may be associated to state-traits of the user based on data gathered from user responses and information input into the platform. For instance, if the platform identifies a high degree of energy from the user, a technique such as image shatter effects may be applied to the collage (or elements within the collage) as a metaphoric approximation of the user state-trait. Because some digital processing effects are computationally complex, such effects may require more processor activity and disrupt the user experience in rendering a collage. Effects requiring greater computation may be pre-rendered at any time and placed in media storage prior to any user engagement that uses such effects. Further, the collage generator component 215 may use a set of predefined design rules or actions, that is, a specific set of manipulation techniques that achieve a predetermined collage aesthetic quality. The collage generator component 215 may use such design rules throughout any step of the process and methodology (e.g., within a question or set of questions). Similar to image processing effects, audio signal processing effects used by the collage generator component 215 may manipulate audio media to be used with (or instead of) manipulated imagery. Such effects may include delay, reverberation, phase, ring modulation, synthesis, pitch shift, time-stretch/compress, and transformation of MIDI data.

One example of an output result is a presentation of a visible graphic display, an audible event, or both visible and audible event. The generated collage may be assembled from source media acquired from user profile data 107, from the media library 108, from a third-party source, and/or from real-time and geo-location data sources. The platform engine 106 may manipulate any of the source media before generating the collage by using digital effects techniques. Other outputs could be in the form of visible and audible presentations consisting of tables, graphs, and charts that identify user response characteristics and magnitudes. Visible media events may include moving images, animations, video, photos, drawings, textures, patterns, colors, shapes, and text. Audible media events may include recorded music, sound, voice, synthesized audio sources or digital music data such as MIDI. Real-time data may include specialized media manually created by platform administrators to be used in the platform engine library as well as calendar information, time stamps, geo-location information, news information, weather data, stock reports, social network feeds, live video feeds, live audio feeds, and other data appropriated from other sources. Once generated, the collage generator component 215 may transmit the resulting collage to the app 111 for further evaluation or manipulation (e.g, to allow a user to further manipulate the results).

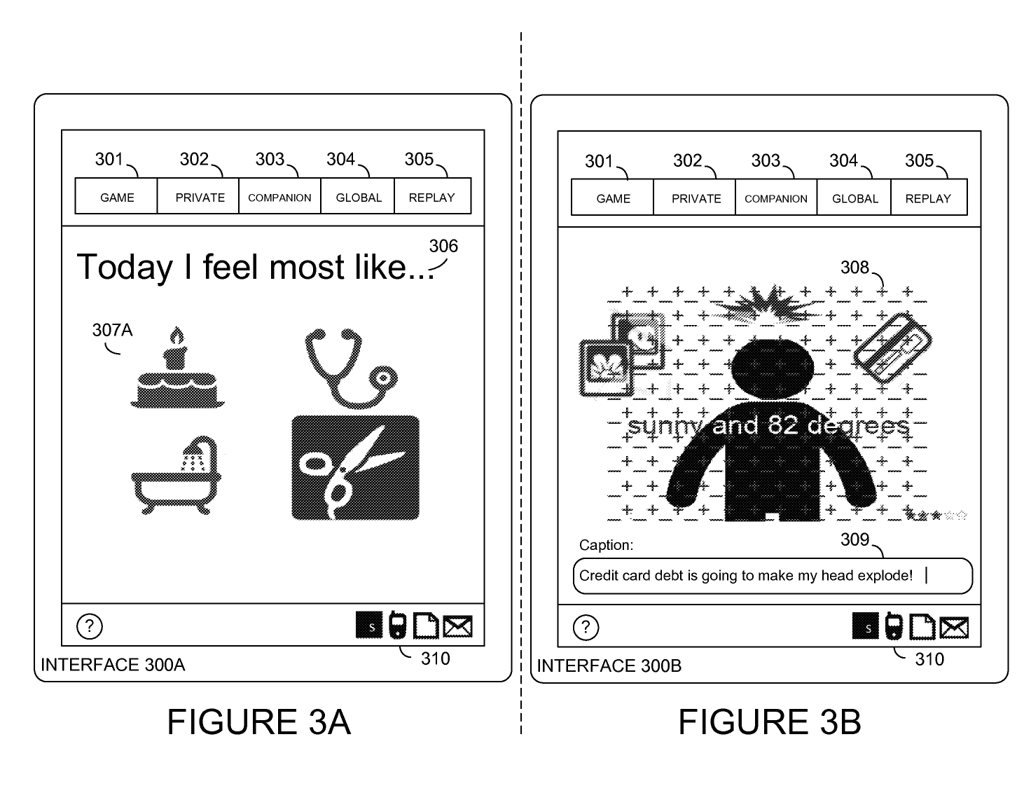

FIGS. 3A and 3B illustrate example touch-screen interfaces 300A and 300B of the app 111 used to communicate with the platform engine, according to one embodiment. Generally, the interfaces 300A and 300B allow a user to respond to questions through various input methods and view a multimedia collage generated after submitting responses to the questions. Illustratively, the interface 300A allows the user to respond by touching an item on the touch-screen. Note, the app 111 may be configured to allow the user to provide response input through other methods. For example, the app 111 may be configured to allow the user to respond to a question by selecting a multiple choice response by typing a letter or a number corresponding to a desired selection, by directly touching and thereby activating a switch corresponding to the response (in cases of touch-sensitive technology), by manipulating a sliding pointer of variable values on a number line or similar scale which correlates to a particular magnitude of the users response, by selecting a coordinate position in an X-Y grid or similar multi-vector scale where several magnitudes may be correlated to the user's response, or by directly typing written responses by use of a keypad or voice recognition system. Each of the input methods may also use a peripheral device that converts body motion, facial motion, eye motion, or voice to select the response. Emerging technologies that sense brain or biometric activity and convert the activity into user intentions and actions may also be used as an input method.

Illustratively, the interfaces 300A and 300B provides several platform modes, as depicted towards the top of the touch-screen. As shown, the interfaces 300A and 300B provides a game mode 301, a private mode 302, a companion mode 303, a global mode 304, and a replay mode 305. Note, the platform modes depicted in FIGS. 3A and 3B are merely examples of platform modes provided. The platform may be configured to support other different modes. Examples of such modes are further described below.

In one embodiment, the game mode 301 enhances the entertainment value of the analysis and outcome. Rather than focusing on the examination of the state of mind of a user over an extended period of time, the game mode 301 enhances the novelty and amusement of the question and response performance. The game mode 301 foregoes the accuracy and integrity of the data collected and required by modes that aid in personal growth or peer communication to emphasize amusement and enjoyment of a given user experience. Further, the game mode 301 may be configured to use the popularity and outcomes of certain questions and response options from multiple users on a select group or global scale. The platform engine 106 analyzes the responses against the totalities and averages of other analyses and trends among a broader group of responses and platform users. The response data metric from other users and previous engagements may be displayed to the current user during or after the current user's engagement with a similar set of calls for user action and questions.

In one embodiment, the private mode 302 specifies a platform state in which the platform engine 106 analyzes personal aspects of user profile data and prior question response iterations. The private mode 302 explores the personal feelings of the user obtained over several analyses iterations and through specific and related question progressions. The private mode 302 may gather specific information provided by a user in the user profile data. Such information may include religious preferences, names of significant people, birthdays, etc. When used in conjunction with third-party user accounts, such information may be gathered from user comments, profile data, purchase behavior data, and other behavioral information provided when the user allows access to such third-party information sources. In addition, the platform collects a progressive list of all keywords and other data such as color or artistic style notations associated with the response media selected by the user. The platform indexes the data to find trends or patterns in the user history. Further, the platform engine 106, in private mode 302, archives user responses and analyzes the responses against similar previously recorded responses and information gathered from the user profile and other third-party sources, which, in turn, allows a user (e.g., through app 111) to provide more clarity to personal issues. For instance, if a user demonstrates a propensity to always select an image of a dog rather than an image of a cat when given those two options, and at the same time determines that the user subscribes to online news about dogs, the platform may determine that this user owns or enjoys interacting with dogs as part of his or her lifestyle. Collecting such user propensities may greatly enhance a user experience with the platform overall. At times, the private mode 302 prevents the app 111 from providing a selection of a question category. The private mode 302 may require the user to provide input of specific textual data (e.g., proper names of people significant to the user) to develop analyses more relevant to the user. Generally, the private mode may be perceived as more serious, specific, and insightful than the game mode 301.

In one embodiment, the companion mode 303 is a mode in which the app 111 runs in the background of the device. The platform engine 106 engages the app 111 at different and spontaneous moments while the device is running. Along with data sources and methodologies used in the private mode 302, the platform engine 106 also accumulates and assesses the operation of the device, e.g., by collecting data from other applications and user activity. Examples of user activity may include search queries performed by the user, geo-location, weather data, activity times, reminders, contacts, dates, and the like. In the companion mode 303, the platform engine periodically sends a call for user action to prompt for a response to the app 111 in response to other activity on the device, search terms, location and/or other behavior (e.g., product purchases, responses to advertisements, etc.). The companion mode keeps a cumulative record of activities and uses the data to associate activities to state-trait cycles and trends revealed in analyses over a period of time.

In one embodiment, the global mode 304 is a mode in which the platform engine 106 occasionally prompts the app 111 for a response to questions that are being presented to all other platform users. The global mode 304 allows a user to evaluate responses in relation to the totality of responses and statistics obtained from other platform users. Consequently, the global mode 304 assists users in identifying social trends and moods to understand the user's uniqueness in comparison to global analytics.

In one embodiment, the replay mode 305 is a mode in which the app 111 may recall identical sets of questions from a previously completed analysis. While in the replay mode 305, the app 111 may allow a user to recall and provide responses to a set of questions from an analysis completed by the user or other platform users. The replay mode 305 allows the user to compare the differences in the outcomes of the separate, yet identical, analyses. The initial user may title the set of questions for easy reference before deploying the analysis set to be shared among peers and other users within a network. The subsequent users may then respond to the same questions within the shared set. At the instance when the subsequent user selects his or her individual response, the platform may display the responses selected by the initial user(s), or in the case of a larger group of users who have previously responded, the platform may display a numeric or graphical percentage value of the totality of responses attributed to each response option. The metrics data displayed allows the user to quickly compare their own responses to each of the questions to those of users who have previously responded. The user may then also compare, comment, and rate on the resultant collages generated by the platform both within the platform structure and through other social communications systems (e.g., via online networks or personal messaging).

In one embodiment, the platform may provide a message mode (not shown) that enhances basic instant messaging and SMS text features. In this mode, the platform engine 106 receives, from the app 111, a selection of a recipient of a message, such as an individual, a group, or an end output platform. After the platform engine receives text message input from the app 111, the platform engine analyzes the text and any other data, such as previous text messages, and correlates the words, meaning, and tonality of the text message to the media library 108 and platform associations. The platform engine then selects media to use and constructs an audio and/or visual multimedia collage. The multimedia collage may then be sent, with or without the source text message, to the assigned recipient. The message mode may be used as a feature added to or run in tandem with existing messaging and photo sharing services.

In one embodiment, the platform may provide a friend mode (not shown) that displays (e.g., on a terminal device) a chart or grid of the resultant collages finalized by a peer group of other users of which the platform user has predefined into the group by a system of selection and mutual acceptance. Such groups may be composed of other users, such as friends, family, or even celebrities and fictional personas engaged with the platform. The user may title, caption, or compose text or other communication in response to a generated collage and send such communication back to the individual associated with the collage. Similar to the replay mode described above, the user may select and also respond to the exact same set of questions and responses from which the other user's collage was derived. The users may then compare their own responses to individual questions in the set and also compare and comment on the resultant collages via online or personal messaging. At any time, users (though the app 111) may offer other users a subsequent opportunity to retake individual analyses to compare and contrast. Collages displayed in the friend mode may be organized and sorted alphabetically, chronologically, or by popularity evidenced by the number of times the particular associated analysis has been replayed and/or rated by other users.

In one embodiment, the platform may provide a live mode (not shown) in which the totality of all platform user data, values, and source media, along with media content including real time news information and cultural trends are all averaged together, layered, composited, mixed, and effected to present a running, motion visual and/or audio stream that constantly evolves in relation to the data and source material input into the platform. When a large group of users input response data into the platform, individual responses may have little effect on the averages that are used to trigger the manipulation of media. While in the live mode, the app 111 allows a user to switch between any of the various platform modes at any time during the process of platform engagement. Running media may be displayed in the live mode to be used on terminal devices such as a computer as a background image or as a screen saver when the operating system of the terminal device, which generally manages wallpaper and screen savers, allows such integration.

In one embodiment, the platform may provide a celebrity mode, where the platform engine 106 may provide the collages of famous persons or characters also using the platform for a user to browse through the app 111. The app 111 may allow the user to replay the analyses from which those collages were derived. The celebrity mode may also include design rules and presets predefined by guest celebrities and artists (e.g., invited by platform administrators to participate). The design rules and presets may be used to generate specific imagery and styles for other collages. Collages displayed in the celebrity mode may be organized and sorted alphabetically, chronologically, or by popularity evidenced by the number of times the particular associated analysis has been replayed or rated by other users.

In one embodiment, the platform may provide a predictive mode. In the predictive mode, the platform engine 106 examines a totality of data derived from previous analyses performed with the user. The platform engine 106 determines trends, cycles, patterns, and repetitive themes in the data to determine input values for generating a new collage. Further, at times while the predictive mode is engaged, the platform engine 106 may examine data obtained from third-party scheduling and calendar platforms to identify additional information about upcoming events. Once obtained, the platform engine 106 may examine the totality of data at specified time periods.

Depending on the mode selection, the platform engine generates a set of prompts and sends the prompts to the app 111. The interface 300A displays an example question prompt 306. Illustratively, the question prompt 306 prompts a user with “Today I most feel like . . . ” The interface 300A provides multiple choice selections 307A. As shown, such selections may correspond to different image data. The image data may be weighted and evaluated differently based on the selected response. Such weighting is discussed in further detail below.

In certain platform modes, the platform allows the user to opt for wider analysis of previously completed analyses. The platform engine 106 may search and average previously saved analysis data in a user profile to create a single set of analysis data displayed with an indicator for the time specified, such as a timeline, calendar, or number line graphic. This overall analysis may be presented in the form of an overall collage or be presented in other reports such as static or animated tables, graphs, or charts. The user may select specific situational parameters to define and be included in the overall analyses such as specified times, days or dates, geo-location, conditions or other associated parameters. The overall analysis processed by the platform engine may also report the magnitude of specific trends tabulated in user responses (or other users' responses) over a period of time or situation. These trends could include subjective information such as specific state-traits, moods, feelings, subject matter, conditions or other associations that are generally presented for comparative analysis by the user (or users).

Once the platform engine 106 receives responses from the app 111 and tabulates the values associated with the responses, the platform engine generates a multimedia collage based on the responses and user data and transmits the collage to the app 111. An example collage 308 is shown in interface 300B. The interface 300B also provides a text field for a user to input a caption 309 (e.g., “Credit card debt is going to make my head explode!”). Alternatively, the caption 309 may store audio input from the user. Further, the user may rate the quality or enjoyment of the collage displayed. The app 111 may subsequently share the collage 308 and caption 309 through various outlets 310, such as by social media, phone message, e-mail, etc. When shared, other users and friends may also comment, rate, and/or retake the analysis from where the collage derived its data.

In addition, the interface 300B may display the multimedia collages in several other manners. For instance, the interface 300B may have a progressive display, in which a small version, or thumbnail, of a multimedia collage in progress is displayed during the while a given user engages the platform. The progressive display allows the user to immediately perceive how each response is applied to the generated collage updated at each question progression. The user may also retroactively go backward through the iterations to return to a prior state of the multimedia collage. As another example, a sneak peek display provides a button or a switch that, when activated, temporarily interrupts the analysis session. During this interruption, the platform engine sends to the app 111 the current state of the collage in progress. As another example, a final display shows the multimedia collage after the given user has completed the session. As another example, multi-display shows a set of several possible collages to the interface 300B, from which the user may select one collage to represent the totality of the analysis. All resultant collages may, at the prompting of the user, be formatted and converted into a file format optimized for the purpose of printing, further manipulation, or otherwise archiving to external devices.

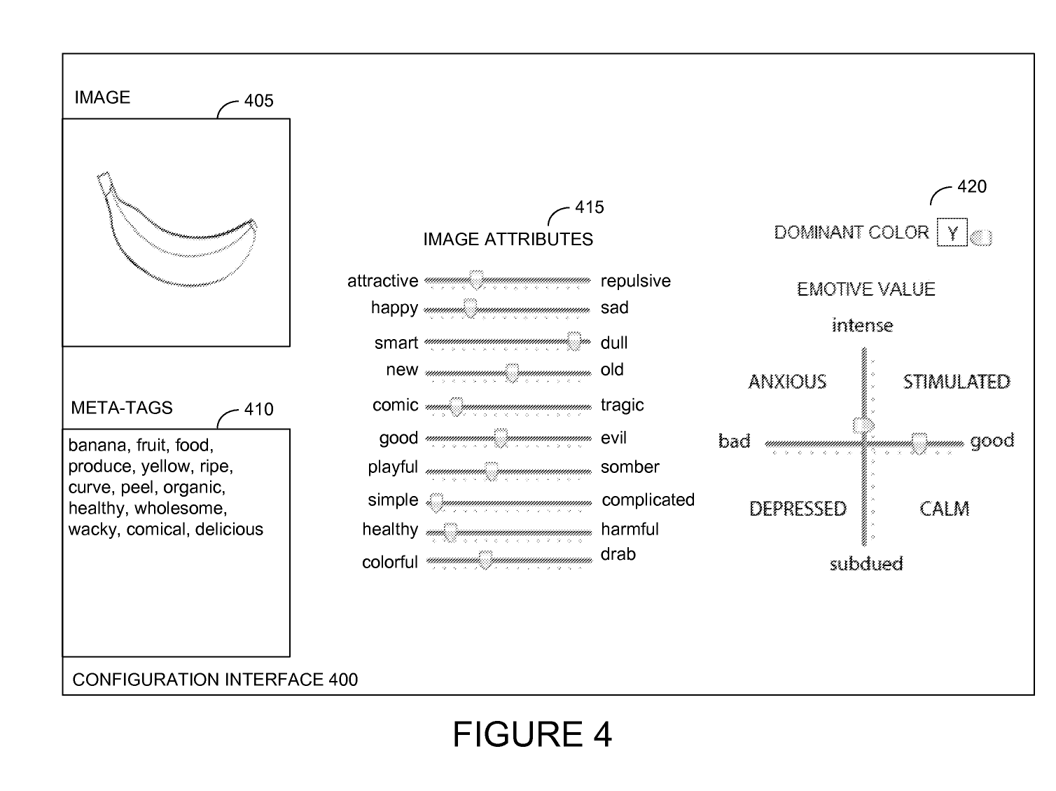

FIG. 4 illustrates an example media item configuration interface 400 of the platform server 105, according to one embodiment. Configuring media items provides statistical data that the platform engine 106 may use to analyze and correlate responses and collage elements. The platform engine 106 uses the data to create, test, and determine relative associations between other media items in the media library 108 (or other external media sources). Further, advertisements may be assessed similarly. For example, assume that the media library 108 provides an image of a banana as a media item. A platform administrator may apply subjective and objective values to the media item from which the platform determines the item's proper user and effectiveness. Such values may be manually applied when the values are proprietary to the platform, or may be obtained from values and descriptions associated to the media item by a third-party library source. Additionally, configurations of media items may be obtained through a crowdsourcing service. As is known in the art, crowdsourcing techniques use input from a large network of human contributors to solve a particular problem. In this context, a crowdsourcing technique may be used to collect, configure, and catalog media items for the platform and may be presented in substantially different forms than the interfaces described herein to optimize data harvesting. One example of such a form may be a game embedded in the platform in which the user is challenged to organize or tag groups of media as rapidly as possible.

In one embodiment, the configuration interface 400 displays the image of the banana as item 405. The interface 400 allows the item 405 to be tagged (e.g., by a platform administrator or outside service) with metadata 410. Illustratively, metadata 410 provided for the image of the banana include “banana, fruit, food, produce, yellow, ripe, curve, peel, organic, wholesome, wacky, comical, delicious.” The item 405 may also be prescribed with certain image attributes 415. The configuration interface 400 may provide a sliding scale for each image attribute 415 (or state-trait), where the each extreme of the scale represents an opposing characteristic (e.g., “attractive” with respect to “repulsive, or “happy” with respect to “sad”). The characteristic traits used to assess the media and/or the platform processes and effects may change or expand to achieve a more enhanced user experience or to improve the performance of the platform.

Further, the configuration interface 400 may also provide an emotive value scale 420. The emotive value scale 420 allows the media item 405 to be further associated with emotive characteristics. As shown, the emotive value scale 420 provides four quadrants that differ in emotive characteristics: anxious, stimulated, depressed, and calm. The emotive value scale 420 also allows for a dominant color to be specified for the media item 405. In this example, the dominant color is specified as Y, for yellow. Further, pre-existing keywords and data (e.g., IPTC metadata) may be associated to emotive values. Doing so allows the platform engine 106 to determine the emotive values autonomously.

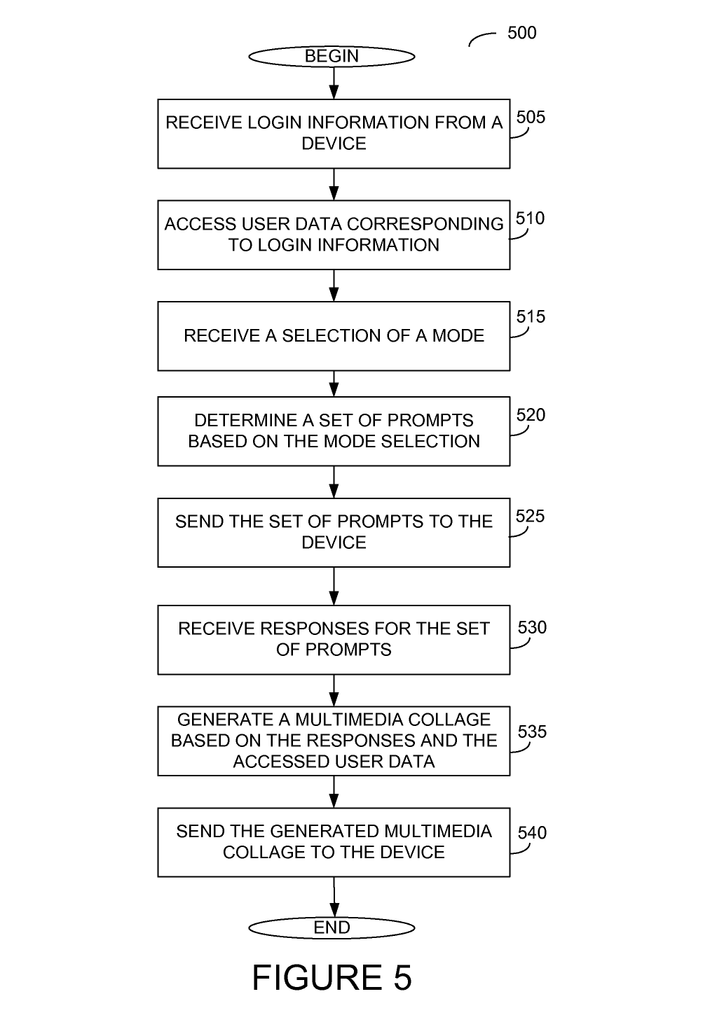

FIG. 5 illustrates a method 500 for generating a collage of multimedia based on analyses of user input, according to one embodiment. The method 500 begins at step 505, where the platform engine receives login information from the app 111 when the user has a pre-existing account and profile but may not always be the situation for users engaging the platform for the first time. At step 510, upon successful login, the platform engine accesses user profile data associated with the login information. Such data may include account information, user-provided images, usage history, and so on.

At step 515, the platform engine 106 receives a selection of a platform mode. As stated, each mode directs a distinct set of processes within the platform engine 106 that enhance various aspects and states in the user experience described above. At step 520, based on the selection, the platform engine 106 generates a set of prompts (e.g., questions) to send to the app 111 running on the device. Such prompts may be in the form of image media, written text, sound media, and the like. The platform engine 106 may perform various algorithms to select the set of prompts. For instance, the platform engine 106 may identify keywords and data associated with the media to create context and meaning for the progression of the analysis process.

At step 525, the platform engine 106 sends the set of prompts to the app 111. In turn, the app 111 sends responses to the set of prompts to the platform engine 106. Responses may be made through various input methods including, but not limited to: selecting a “multiple choice” response by typing a letter or number corresponding to the selection, directly touching and thereby activating a switch that corresponds to the response when touch-sensitive technology is available, manipulating a sliding pointer of variable values on a number line or similar scale which correlates to a particular magnitude of the response, selecting a position in an X-Y grid or similar multi-vector scale where several magnitudes may be correlated to the response, or directly typing written responses by use of keypad or voice recognition system. Each input method may also use peripheral devices that convert body motion, facial motion, eye motion, voice, or brain activity to select the response.

At step 530, the platform engine 106 receives the responses for each iteration of the set of calls for user input prompts from app 111. The platform engine 106 tabulates and assesses the responses and the obtained user data. The platform engine 106 correlates the data by associating similarities of values, keywords, description, quality or conceptual context, with media items from the media library 108 or media obtained from a third party library. Further, the platform engine 106 may correlate the data with statistical information and social trends obtained from other sources (e.g., local databases tables storing such information) through mathematical algorithms and artificial intelligence data processing. Examples of statistical information may include emotive values of other media, keyword associations, metadata associated with each response, and a frequency at which a response has been associated with other media. The platform engine 106 may define a proprietary set of values that represent the totality of responses of a given user. Individual values within this set may include degrees of traits, such as sadness to happiness, active to sedentary, or healthy to ill. The platform engine 106 detects patterns in such trait values to establish a metric of the user's state within these individual traits or averages these values to denote an overall metric of well-being or state of mind. The collected and analyzed values correlate to other media in the library which have been pre-identified manually or from outside data catalogs to possess similar trait values or may be identified through associated keywords found in either the image metadata or have already been attributed to the media manually (e.g., via third-party categorization or via crowd-sourced categorization). The platform engine 106 thereafter selects relevant correlated media to be used in the generated collage by searching for media with similar or contrasting trait values or by associations to keywords presently attributed to media. An example of such a keyword association could be the trait “sadness,” metaphorically associated to media which visually and/or sonically connote “stormy weather.” Additionally, the platform engine may collect real-time data and media from various “live” sources, such as news, weather, headlines, geo-location data, and trending media and use such sources to identify correlations to the user's current state, e.g., in associating “sadness” with declining stock market values.

At step 535, the platform engine 106 generates a multimedia collage based on correlated data and values. To do so, the platform engine 106 processes image and sound data obtained from the media library 108 and processes the data through a variety of image processing techniques. The platform engine 106 uses various editorial, layering, and blending techniques common to multimedia design and production to create the multimedia collage. At step 540, the platform engine 106 sends the generated multimedia collage to the device. The app 111 may further evaluate or manipulate the generated collage. Further, the app 111 may send an indication to the platform engine 106 to continue with subsequent iterations of prompts or restart the question and analysis process.

In one embodiment, the platform engine 106 may be configured to generate different questions at each iteration of the analysis. Further, depending on the platform mode selected, the app 111 may provide to the platform engine 106 a selection of a question category from a list of categories. The categories define the direction and progression of the analysis process. Question categories may include areas of topics such as relationships, work, love, finance, faith, health, hope, world issues, politics, and the like. The app 111 may send a selection of a question category or a request to randomize the category and associated questions. The question category determines the nature or subject matter of the question served to the user. The data collected may trigger a specific line of questioning relevant to the user to focus on or clarify patterns of user behavior and/or subject matter in which the user demonstrates repeated interest. Under this line of questioning, a user may input specific textual information that cannot be derived from heuristics. Such data may include proper names of people, places, things, micro-geographic location descriptions unavailable by GPS resolutions, and unique, user-specific situations. In some platform modes, the platform engine 106 may select the question category automatically.

Additionally, the platform engine 106 may include an opinion category. Under the opinion category, a current event, news item, or cultural situation is presented to the user in order to obtain a response specific to that current moment or situation. The opinion category could be used to collect and provide opinion poll data to third-parties.

Further, at any point in the analysis, the platform engine 106 may receive a notification to discontinue the process, at which time the platform engine 106 sends a prompt to the app 111 requesting a selection of whether to save the progress of the analysis as data to be resumed at a later time or to quit without saving the progress and analysis data. Additionally, the platform engine 106 may receive a selection to end the session and initiate assembly and presentation of the generated collage to the app 111. The platform engine 106 may also receive an indication from the app 111 to start an entirely new session from the beginning to generate a different set of questions.

In one embodiment, the platform may provide users with opportunities to obtain virtual and/or financial rewards through a separate monetization application. Such an application may incentivize users to further engage with the platform. For example, the application may generate rewards through a point-system for a given user profile for usage of the platform over specified durations or time, for responding to specified numbers of questions, for inviting other individuals to try the platform, for replaying question sets sponsored by a charity or celebrity, for using advanced or beta features of the platform, or for achieving prescribed goals. Rewards points may be used in assigning a hierarchy of virtual “badges” to a user account. A badge is a small graphic that may be displayed in a user profile or collage identifying a level of accomplishment. Rewards points may also be used to unlock new features to permit the use of previously blocked advanced features, to receive discounts to paid versions of the platform, or to receive discounts on platform subscription fees for the user account, or to receive off-platform incentives from affiliate entities such as free products or discounts in the form of coupons, gift cards, or other redeemable certificates. Further, reward points may be redeemed to gain access to specialized, limited edition question sets and content authored by celebrities and/or guest artists. More specifically, celebrities, artists, and the like may develop design rules and a set of predetermined special images to be used in both the analyses and in the collages. Using the design rules and set of special images, collages generated by the platform engine may include aesthetic styles, imagery, sound, and signature ideas associated to the guest artists, celebrities, or institutions.

The app 111 may archive the collage and analysis data for later use, such as for personal reflection, analysis of emotional trends and cycles, and comparison to other time frames and situations. Alternatively, the app 111 may allow the user to delete the collage and associated data. Further, the app 111 may allow the user to archive the collage by storing the collage and associated data to a user profile (or the device on which the app 111 is installed). The file format of the collage may be converted to standard file formats common to digital devices, such as jpg, png, gif, mp3, mp4, way or other standard, digital-visual, and auditory formats. The app 111 may also distribute the multimedia collage through different channels, such as social networks, peer-to-peer networks, peer-to-group networks, e-mail, text message, or any user-identity based usage. For example, the app 111 may send the collage file and associated analysis data to a user profile repository maintained by the platform engine 106. In turn, the platform engine 106 may make the collage available for authorized users to view. As another example, the app 111 may send the collage file and analysis data to publically accessible sources over the network 120 for anyone to observe and/or replay and respond to the associated analysis. Further, the app 111 may send the collage file to social network accounts (e.g., Facebook, Twitter, Google+, Pinterest, WhatsApp, and so on) linked to a user profile on the platform.

Additionally, the platform engine 106 may send the collage file and analysis data to a digital repository which can then be accessed by third-party email or other communication client software for the purpose of distributing the collage and data via the network 120 to other parties specified by the user.

When an archiving option is selected, the platform engine 106 may perform any necessary file conversions and/or transcoding to optimize the file for additional ancillary use. As stated, a user may create voice, video, or textual annotations that accompany generated collages and output. When output is shared with other users, a user may allow other social network users to append their own comments and notations to be added adjacent to an initial caption by the user (e.g., through a dynamically expanding textual list, selectable grid, etc.). Other social network users may ascribe qualitative values to the generated collage or output through a rating (or similar peer judgment) structure. These ratings, along with associated comments, may be used for heuristic analysis of the performance of certain aspects of the platform, to monitor content deployed into the platform, and/or to evaluate user activity and progress. The user can also allow other users to share the output with others throughout their own social networks. All resultant collages may contain embedded metadata identifiers that associate the output back to the questions, response options, source material, analysis and algorithms used to develop the resultant output. The analyses may be saved and/or shared for subsequent multiple replays by the user (or by other users given access to the data).

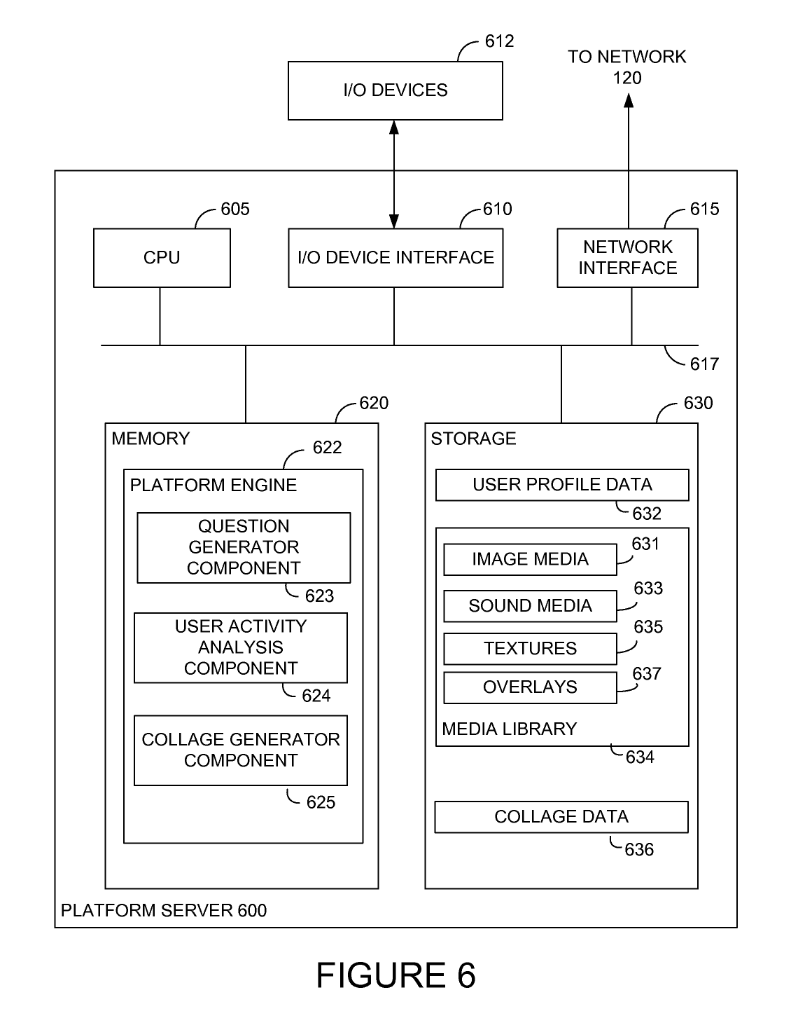

FIG. 6 illustrates an example platform server 600, according to one embodiment. As shown, the platform server 600 includes, without limitation, a central processing unit (CPU) 605, a network interface 615, a memory 620, and storage 630, each connected to a bus 617. The platform server 600 may also include an I/O device interface 610 connecting I/O devices 612 (e.g., keyboard, display, wearable devices, and mouse devices) to the platform server 600. Further, in context of this disclosure, the computing elements shown in the platform server 600 may correspond to a physical computing system (e.g., a system in a data center) or may be a virtual computing instance executing within a computing cloud.

The CPU 605 retrieves and executes programming instructions stored in the memory 620 as well as stores and retrieves application data residing in the storage 630. The interconnect 617 is used to transmit programming instructions and application data between the CPU 605, I/O devices interface 610, storage 630, network interface 615, and memory 620. Note, the CPU 605 is included to be representative of a single CPU, multiple CPUs, a single CPU having multiple processing cores, and the like. And the memory 620 is generally included to be representative of a random access memory. The storage 630 may be a disk drive or a solid-state storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 620 includes a platform engine 622. The platform engine 622 itself includes a question generator component 623, a user activity analysis component 624, and a collage generator component 625. The storage 630 includes user profile data 632, a media library 634, and collage data 636. The media library 634 may include image and moving image media 631, sound media 633, textures 635, and overlays 637. The platform engine 622 manages platform processes, various users, data repositories, media repositories, data archives, and platform states. The question generator component 623 is configured to create a set of prompts. The user activity analysis component 624 is configured to analyze responses of the obtained set of questions and user profile data 632. The collage generator component 625 generates, from the analyses, a multimedia collage that provides a visual and/or auditory experience to a user. The collage may be generated using media from the media library 634 or media obtained from third-party sources. The generated collage and the associated data used to generate and present the collage may be stored on the platform server 600 as collage data 636.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the present disclosure may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

While the foregoing is directed to embodiments of the present disclosure, other and further embodiments disclosed may be devised without departing from the basic scope thereof, and the scope thereof is determined by the claims that follow.

I claim:

1. A method for generating media based on input received from a client device, comprising:
receiving user profile information and a selection of a performance mode from a client device;
generating one or more prompts based on the selected performance mode and on the user profile information, wherein each of the one or more prompts corresponds to one of a plurality of media items stored in a data store, and wherein the media item is one of an image, a sound, a video, or text stored in a first data store;
sending the one or more prompts to the client device;
receiving responses to each of the one or more prompts from the client device, wherein each of the responses correspond to one or more of the media items stored in the first data store;
correlating the responses and the profile information with statistical data obtained from a second data store and the plurality of media items; and
generating a collage of multimedia based on the correlated responses, profile information, and media items, wherein the collage of multimedia includes at least one of the media items.

2. The method of claim 1, further comprising, sending the collage of multimedia to the client device.

3. The method of claim 1, wherein the generated one or more prompts is further based on prompts provided by at least one third-party advertiser.

4. The method of claim 1, wherein the performance mode is one of a game mode, a private mode, a companion mode, a global mode, a replay mode, a message mode, a friend mode, a live mode, a celebrity mode, and a predictive mode.

5. The method of claim 1, wherein each of the media items include metadata associating the media items with individual properties, descriptions, and moods.

6. The method of claim 1, wherein the user profile information includes account settings, user-provided media items, and usage history.

7. The method of claim 1, further comprising, storing the generated multimedia collage in a third data store.

8. A non-transitory computer-readable storage medium storing instructions, which, when executed on a processor, performs an operation for generating media based on input received from a client device, the operation comprising:
receiving user profile information and a selection of a performance mode from a client device;
generating one or more prompts based on the selected performance mode and on the user profile information, wherein each of the one or more prompts corresponds to one of a plurality of media items stored in a data store, and wherein the media item is one of an image, a sound, a video, or text stored in a first data store;
sending the one or more prompts to the client device;
receiving responses to each of the one or more prompts from the client device, wherein each of the responses correspond to one or more of the media items stored in the first data store;
correlating the responses and the profile information with statistical data stored in a second data store and the plurality of media items; and
generating a collage of multimedia based on the correlated responses, profile information, and media items, wherein the collage of multimedia includes at least one of the media items.

9. The computer-readable storage medium of claim 8, wherein the operation further comprises, sending the collage of multimedia to the client device.

10. The computer-readable storage medium of claim 8, wherein the generated one or more prompts is further based on prompts provided by at least one third-party advertiser.

11. The computer-readable storage medium of claim 8, wherein the performance mode is one of a game mode, a private mode, a companion mode, a global mode, a replay mode, a message mode, a friend mode, a live mode, a celebrity mode, and a predictive mode.

12. The computer-readable storage medium of claim 8, wherein each of the media items include metadata associating the media items with individual properties, descriptions, and moods.

13. The computer-readable storage medium of claim 8, wherein the user profile information includes account settings, user-provided media items, and usage history.

14. The computer-readable storage medium of claim 8, wherein the operation further comprises, storing the generated multimedia collage in a third data store.

15. A system, comprising:
a processor and
a memory hosting an application, which, when executed on the processor, performs an operation for generating media based on input received from a client device, the operation comprising:
receiving user profile information and a selection of a performance mode from a client device;
generating one or more prompts based on the selected performance mode and on the user profile information, wherein each of the one or more prompts corresponds to one of a plurality of media items stored in a data store, and wherein the media item is one of an image, a sound, a video, or text stored in a first data store;
sending the one or more prompts to the client device;
receiving responses to each of the one or more prompts from the client device, wherein each of the responses correspond to one or more of the media items stored in the first data store;
correlating the responses and the profile information with statistical data stored in a second data store and the plurality of media items; and
generating a collage of multimedia based on the correlated responses, profile information, and media items, wherein the collage of multimedia includes at least one of the media items.

16. The system of claim 15, wherein the operation further comprises, sending the collage of multimedia to the client device.

17. The system of claim 15, wherein the generated one or more prompts is further based on prompts provided by at least one third-party advertiser.

18. The system of claim 15, wherein the performance mode is one of a game mode, a private mode, a companion mode, a global mode, a replay mode, a message mode, a friend mode, a live mode, a celebrity mode, and a predictive mode.

19. The system of claim 15, wherein each of the media items include metadata associating the media items with individual properties, descriptions, and moods.

20. The system of claim 15, wherein the user profile information includes account settings, user-provided media items, and usage history.
